(19) United States
(12) Patent Application Publication
(10) Pub. No.: US 2005/0099761 A1
(43) Pub. Date: May 12, 2005

(54) Field converter for thrust generation

(75) Inventors: Douglas G. Torr, Fayetteville, NC (US); Jose G. Vargas, Columbia, SC (US); Michael H. Graff, Casselberry, FL (US)

Correspondence Address: STEPTOE & JOHNSON LLP;ATTORNEYS AT LAW, 1330 Connecticut Avenue, NW, Washington, DC, 20036-1795, US

(73) Assignee: PST ASSOCIATES, LLC, Fayetteville, NC (US)

(21) Appl. No.: 10/941,029

(22) Filed: Sep. 15, 2004

Related U.S. Application Data
(63) Continuation-in-part of application No. 10/271,782, filed on Oct. 17, 2002.
(60) Provisional application No. 60/329,764, filed on Oct. 18, 2001.

(51) Int. Cl. H01G 4/20

(52) U.S. Cl. 361/312

(57) ABSTRACT

An apparatus for generating an inhomogeneous electric field that can produce thrust having a first electrode constructed of a first conducting material, a second electrode constructed of a second conducting material separated from but in proximity of the first electrode and a first and second dielectric material interposed between the first and second electrodes, the first and second dielectric materials having a high and low mass density, respectively.

### REFERENCE TO RELATED APPLICATIONS

This application is a continuation-in-part of application Ser. No. 10/271,782, filed Oct. 17, 2002, which in turn claims the benefit of U.S. Provisional Application No. 60/329,764, filed Oct. 18, 2001.

### BACKGROUND OF THE INVENTION

1. Field of the Invention

The invention relates to the generation of inhomogeneous electromagnetic fields and, in particular, to the generation of those fields that will result in gravitational thrust. Such systems have utility in the arts of mass acceleration or deceleration and object manipulation.

2. Discussion of Background Information

All interactions in nature have been historically described in terms of four elementary forces: the strong force, the weak force, the electromagnetic force, and gravity. The strong force holds atomic nuclei together and is responsible for the energy released by nuclear reactions. The weak force is associated with radioactive decay and interactions between sub-atomic particles called neutrinos. Both strong and weak forces act over relatively short (e.g., sub-atomic) distances. The electromagnetic force can act over much longer distances than the strong and weak forces. For example, the electromagnetic force keeps directional compasses pointed north over the entire surface of the Earth. The electromagnetic force is also responsible for the attraction and repulsion of charged particles. The farthest-ranging forces are gravity and the electromagnetic force. Gravity keeps the Earth orbiting the Sun and can act over distances on a galactic scale.

An important issue in physics is the interaction of the four fundamental forces. Many physicists believe that the four fundamental forces can be described by a single unified theory. For example, the Standard Electroweak Theory explains how the electromagnetic and weak forces interact and relate to each other. The Standard Electroweak Theory unifies the weak force and the electromagnetic force. Other theories supply explanations of how the strong force, the weak force, and the electromagnetic forces interact. Theories that harmonize all four fundamental forces are called “Super Unification” theories.

There have been reports of gravitational effects produced by devices involving various combinations of time-dependent electromagnetic and static electric and magnetic fields. Recent years have witnessed attempts to develop these technologies, as evidenced by the interest exhibited by various government agencies including NASA, DOD and the Department of Energy.

In July 2001, a three-day meeting of the American Institute of Aeronautics and Astronautics (AIAA) was held in Utah. V. Roschin and S. Godin presented a paper entitled “An Experimental Investigation of the Physical Effects in a Dynamic Magnetic System,” (American Institute of Aeronautics and Astronautics 2001 Meeting, AIAA-2001-3660). The paper described an assembly of static and rotating magnets, which purportedly achieved a gravitational effect. The authors reported reductions in observed weight ranging up to 35%. However, the paper gave no theoretical basis for the result.

T. Datta et al published a paper entitled “A gravitational Experiment Involving Inhomogeneous Electric Fields,” (American Institute of Physics Proceedings of the STAIF Conference, Albuquerque, N. Mex., vol. 699, Ed. Mohamed S. El-Genk, February 2004) that claims to have observed a gravitational effect in an experiment that placed a test mass in an electric field. They reported a change in weight of up to 6.4 parts in 10⁶. An inhomogeneous electric field was produced by an electrode pair comprised of a cone and a flat plate.

Reference is also made to U.S. Pat. Nos. 6,317,310 and 6,411,493 which disclose an asymmetrical capacitor capable of producing thrust.

The first contributions to a quantitative theoretical understanding of the coupling between gravitational and electromagnetic fields can be found in J. G. Vargas & D. G. Torr, “The Cartan-Einstein Unification with Teleparallelism and the Discrepant Measurement of Newton's Constant G,” Foundations of Physics, 29, 1999, pp. 145-200, in “Is electromagnetic Control of Gravity Possible” (American Institute of Physics Proceedings of the STAIF Conference, Albuquerque, N. Mex., vol. 699, Ed. Mohamed S. El-Genk, 2004a), and in “Electrically Induced Gravitation in Finslerian Teleparallelism” (To be published in the Journal of Mathematical Physics 2004b).

Unification theories often use complex mathematical ideas. In particular, attempts have been made to develop physical theories using techniques from relativity, differential geometry, phase space-time, teleparallelism, exterior differential calculus, Clifford algebras, Kähler calculus, and other physical and mathematical theories. Tensors, which are known in the art, arise in attempts to explain some physical phenomena. Tensors have components that may be differential n-forms (where n is an integer), functions, or other tensors. Tensors have notations involving superscripts and subscripts that are conventionally defined and understood by those of skill in the art. Differential geometry is particularly useful in studying fundamental forces and space-time. Mathematical constructs and techniques known in the art of differential geometry include matrices, connections, differential forms, products (including interior, exterior, inner, outer, and Clifford), metrics, contractions, contravariance, covariance, and fields.

### SUMMARY OF THE INVENTION

An arrangement of electric-field-generating systems and methods are disclosed. In particular, embodiments that produce inhomogeneous electric fields that will result in thrust are disclosed.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows with reference to the noted plurality of drawings by way of non-limiting examples of certain embodiments of the present invention, in which like numerals represent like elements throughout the several views of the drawings, and wherein:

FIG. 1 illustrates a cylindrical field converter (“FC”) cell with a dielectric comprised of two semi-cylinders of materials of different density;

FIG. 2 illustrates the forces present in the field converter of FIG. 1;

FIG. 3 illustrates examples of arrays of cells for various applications; and

FIG. 4 illustrates a flywheel driven by an array of field converter cells.

### DETAILED DESCRIPTION OF EXEMPLARY EMBODIMENTS

1. Description of the Theory

The following is an abbreviated summary of the underlying theory. The equations and their relations reflect the current understanding of the disclosed phenomenon. However, those skilled in the art may practice the invention even without a full understanding of its theoretical underpinnings. That is, it is not necessary for one of ordinary skill in the art to grasp the physical theory upon which the invention is based in order to make, use, and practice the invention.

In simple terms, a charge distribution that gives rise to inhomogeneous electric fields will act as a source of a gravitational field. The theoretical relationship is set forth below.

The core relationship that provides a coupling constant relating the components of the electromagnetic (EM) field with those of the geometrical object called torsion, which also affects the curvature of space-time, is:
R⁰_{μν}=−CF_{μν}R^{λ}_{μν}=0 for i>0 (1)
where F_{μν} is the EM field tensor, the R^{λ}_{μν} terms (set to zero in general relativity) are the components of the torsion tensor for λ=0, . . . 3, and C is the coupling constant given by:
C=(2G)^{1/2}/c² (2)
in the Gaussian system. The R^{λ}_{μν} components of the torsion tensor are vector-valued 2-forms, where λ is the vector index (the space-time dimension) and μ,ν are the differential form indices. See also, J. G. Vargas & D. G. Torr (1999a) which is incorporated herein by reference in its entirety. G is the universal gravitational constant and c is the speed of light. The relationship results from the addition, or more precisely the emergence, of a non-zero torsion term to general relativity, though in the Finsler bundle rather than in the usual tangent bundle. Otherwise, the validity of Eqs. (1) may be questioned because of purported non-invariance of those equations under boosts (we report, however, that some would justify our equations even in a pre-Finslerian context because, they would argue, the boosts are transformations that relate only to the subscripts of the torsion, not to the superscripts).

A torsion term in the context of teleparallelism permits a new derivation of the right hand side of Einstein's famous equation that relates the curvature of space to energy and momentum. The new Einstein equations retain the usual form:
G_{μν}=−T_{μν} (3)
where the term G_{μν} (which includes tensor indices) is the Einstein geometric tensor derived from the Riemann tensor by way of the Ricci tensor, and T_{μν} is the energy-momentum tensor from general relativity, which depends on the torsion referred to above. The equation
Ω_{μ}^{ν}=−(dβ_{μ}^{ν}−α_{μ}^{λ}\hat{ }β_{λ}^{ν}−β_{μ}^{λ}\hat{ }α_{λ}^{ν})+β_{μ}^{λ}\hat{ }β_{λ}^{ν}, (4a)
which is also written as
Ω_{μ}^{ν}=−(dβ_{μ}^{ν}−ω_{λ}^{λ}\hat{ }β_{λ}^{λ}\hat{ }βω_{λ}^{ν})+β_{λ}^{λ}\hat{ }β_{λ}^{ν}, (4b)
is the expression of the metric curvature of space-time as a function of other geometric quantities that represent different physical fields, and the electromagnetic field in particular.

The Einstein contraction of Eq. (4) is a geometric version of (3), where such contraction is defined by the relation between the metric curvature differential form Ω_{μ}^{ν} and the Einstein tensor, G_{μν}. The energy-momentum of the non-gravitational interactions are to be found on the right hand side of this contracted equation, which is to be preferred over Eq. (3) since it does not have to be brought from everywhere else in the physics, unlike in Eq. (3). The symbol “\hat{ }” denotes exterior product. The β term is the contorsion. The components of β are linear combinations of the components of the torsion and are thus related to the EM field. That is, the β terms can be expressed in terms of R^{λ}_{μν} and therefore by equation (1) include the EM contributions to the right hand side of (3). Equation (3) is to be identified now with the contracted version of Eqs. (4). After appropriate identification of geometric quantities as physical quantities, this geometric T_{μν} contains the standard energy-momentum term of standard electrodynamics plus some additional terms. Though the dβ_{μ}^{ν} term is the derivative of the electromagnetic and other fundamental fields, embodiments of the present invention are typically concerned with the electromagnetic field. However, the invention may be made, used, and practiced without understanding the theory disclosed herein.

The relation between formulas (3) and (4) is as follows. One expresses the right hand side of equations (4) in terms of the torsion components R^{λ}_{μν} and gathers together the terms that correspond to T_{μν} for each μand ν. One uses the first Bianchi identity and integrates by parts in the contraction of the right hand side of Eq. (4b). By expressly identifying T_{μν} where μ=ν=0 (i.e., Tₒₒ) in said contraction with Tₒₒ from the theory of electrodynamics, the constant C in (1) can be determined.

The Einstein contraction of the terms in parenthesis in equation (4) did not appear in Einstein's original equations. The first of these terms is an electromagnetic source of gravity, whereas the last two terms pertain to inertial sources. For reasons not necessary for the understanding of the invention, it suffices to consider only the new term, dβ_{μ}^{ν}. It can alter the metric structure of space-time, which is described by the metric curvature Ω_{μ}^{ν}. It is the derivative of the torsion and therefore of the EM field.

The term dβ_{μ}^{ν} is the theoretical key to inducing gravitational effects. Since the derivatives of P are linear combinations of the derivatives of the torsion, equation (1) indicates that control occurs through inhomogeneous and/or time dependent electromagnetic fields. An inhomogeneous electric field can therefore cause a variation in the gravitational force (e.g., weight) experienced by a body.

Calculations for such a theory are possible for the Coulomb field. The earth has a radial-symmetric electric field (E) of about 100 volts per meter. We represent the field of the spherically symmetrical earth by a Coulomb field and neglect the effect of ionosphere, Vargas & Torr (2004b). The inhomogeneity in this electric field will produce a change in weight of objects of less than 1 parts in 5×10¹. The strength of the earth's electric field is relatively small, which could account for the fact that gravitational effects have not previously been recognized. Also, the derivative of the field varies as E/R, where R is the distance from the center of the earth and E is the electric field. R is a relatively large number at the earth's surface, which greatly reduces the magnitude of the inhomogeneity of the field.

The continuing development of the technology is based on the assumption that the affine connection of space-time is teleparallel. This assumption is, in other words, the restriction that the affine connection of space-time must allow for the relation of equality of tangent vectors at different space-time points independently of the path used for the comparison. Teleparallelism (TP) was postulated by A. Einstein in the late twenties in his paper, “La Theorie unitaire du Champ” (Ann. Inst. Henri Poincaré, 1, 1-24 1930), but it was only the great mathematician E. Cartan who started to find out its potential for physics. See Elie Cartan-Albert Einstein, Letters on Absolute Parallelism 1929-1932 (R. Debever, Editor, Princeton University Press, Princeton, 1979).

The type of process followed to obtain fully geometric gravitational Einstein field equations from the postulate itself of TP must in fact have been followed previously by Cartan, when he wrote in said correspondence with Einstein
2R_{αβ}=Λ_{βαμ;}^{μ}+Λ_{αβμl}^{μ}−φ_{α;β}−φ_{β;α}+Λ^{ρ}_{α}^{μ}_{βμρ}+Λ^{ρ}_{β}^{μ}Λ_{αμρ}+S_{α}S_{β}−(Λ_{βαρ}+Λ_{αβρ})φ^{ρ}+2Λ^{σ}_{αρ}Λ_{αβ}^{ρ}−g_{αβ}S_{μ}S^{μ}, 5)
where “;” denotes covariant differentiation, where R_{αβ} is the Ricci tensor, where gap is the metric, and where all other quantities are either the components themselves of the torsion (A_{βαρ}) or other quantities defined in terms of them by Einstein himself. The cumbersomeness of this Ricci contraction of the statement of TP (zero affine curvature) is due to the fact that Cartan was using the mathematical language and concepts that Einstein had been struggling with, Cartan having the very obvious intention of trying to get down (with regards to matters of exposition) to the level of Einstein. Nevertheless, the relation between electromagnetic field and torsion, independently found by H. I. Ringermacher in his paper “An Electrodynamic Connection” (Classical and Quantum Gravity, 11, 2383-2392, 1994) and by J. G. Vargas in “On the Geometrization of Electrodynamics” (Foundations of Physics, 21, 379-401, 1991) was still missing. Had Cartan looked into this issue and found this solution, it would immediately have occurred to him that the geometry has to be Finslerian, even if the metric indeed remains Riemannian.

Since our previous patent, computations have been polished and a tailor-made powerful Kaluza-Klein formalism has been developed to make the theory capable of addressing ever more complex issues and situations. With regards to computations, we have shown (Vargas & Torr, 2004b) that the Reissner-Nordstrøm solution of the gravitational field of a charged spherical object is missing a most important term. This is due to the fact that, in computing the Reissner-Nordstrøm metric, physicists are overlooking a contribution to the electromagnetic energy-momentum that we discover through TP. This overlooked term does not have consequences in electrodynamics because its integration over the whole of space yields zero. Any term of this sort has, however, gravitational consequences, as pointed out clearly by R. P. Feynman & al in chapter 27 of the second volume of “Lectures on Physics,” (Addison-Wesley, Reading, Mass., 1963). We have discussed this issue in the Proceedings of STAIF (Vargas & Torr, 2004a). In the same proceedings, positive data obtained by Datta et al (2004) on the generation of gravitation by electromagnetic means has been published.

With regards to formalism, the Kaluza-Klein particles-in-fields geometric version of electrodynamics allows one to sort out issues that have to do with the relation between the usual term and the hidden (additional, no electromagnetic consequences) term for electromagnetic energy-momentum. See the paper “Foundational Implications of a Classical Geometrization of Electrodynamics,” by Vargas and Torr (Journal of Mathematical Physics, to be published, 2004c). This is a very major achievement since the first Bianchi identity entangles quadratic terms in the (electromagnetic) field and linear terms in the derivatives of the same. In turn, this achievement of settling the issue of electromagnetic energy allows one to go further and to see all the terms in the geometric Einstein equations in a way more consistent with unification: all terms represent contributions to the energy-momentum distribution, as opposed to the present view where we mysteriously have a term (the Einstein tensor) that is geometric but does not represent any energy-momentum, and the other terms that are not geometric but represent energy-momentum. In the new view, all terms are geometric and all of them represent energy-momentum. In this way, the long-sought gravitational energy-momentum term becomes explicit and is tensorial (Vargas and Torr, 2004c).

2. Embodiments

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The present disclosure shows preferred electrode configurations that give rise to inhomogeneous electric fields that will generate gravitational thrust in a controllable manner.

The creation of inhomogeneities, i.e., the divergence or convergence of electric field lines, can be achieved, for example, with a system of electrodes with curvature to the surfaces, e.g., spherical, cylindrical, elliptical, parabolic, etc., all of which constitute various classes of inhomogeneous capacitors that can be used to create asymmetrical and inhomogeneous fields of various geometries. Cylindrical symmetries are presently preferred for their simplicity and suitability for illustration of self-propulsion devices. However, it should be understood that any of the electrode configurations disclosed in parent application Ser. No. 10/271,782, filed Oct. 17, 2002, the corresponding PCT application of which was published on Apr. 24, 2003 as International Publication No. WO 03/034580, the disclosure of which is expressly incorporated herein by reference, may be used in accordance with the teachings of the present invention. This includes electrode-pair cells which are conic, cylindrical and mirror cells, as well as flat sheet or plate, or flat or curved grid cells.

The FC Propulsion Engine:

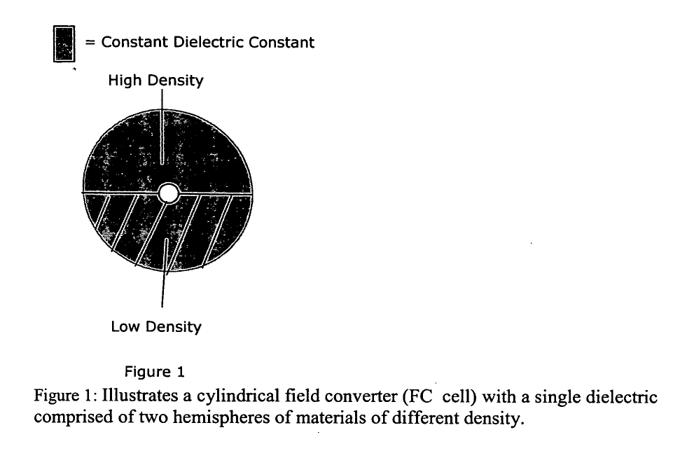

FIG. 1 illustrates a cell configuration for a cylindrical self-propulsion engine. In general, the device shown in FIG. 1 is an illustrative example of an inhomogeneous capacitor that can produce gravitational thrust. The capacitor has preferably two electrodes constructed of conducting material such as a metal (e.g., aluminum, copper, silver, gold, etc.) or other conductors of higher resistivity, such as doped semiconductors or doped ceramic materials etc. The electrodes are in proximity of one another and have a dielectric material interposed therebetween. The non-limiting example shown in FIG. 1 is a cylindrical capacitor. We have chosen to focus on the cylindrical configuration, because this is the only configuration at this time for which quantitative engineering calculations have been done for design purposes. For the cylindrical example cited, the dielectric will preferably be comprised of at least two materials of high and low mass density with preferably the same value for the dielectric constant (k) if electrical isotropy is desired. Alternatively, the high-density material would preferably have the highest k possible, and the low density material the lowest k possible. The advantage of electrical isotropy at this time is that it allows the option for quantitative prediction for engineering design. It is expected that this capability will be developed for electrically anisotropic dielectrics in the future.

The high-density material will fill preferably one-half of the space between the electrodes, and the low density material the other half. The dielectric constant should be as high as possible, preferably 5000, more preferably 10,000 and most preferably higher than 50,000. The mass density of the high-density material should preferably be as high as possible, and that of the low density material as low as possible provided that k is approximately the same for the two materials if quantitative engineering design calculations are required. The first versions of the invention may be limited by the availability of materials fitting the above description optimally. However, as the demand for better performance of the device increases, better materials will be developed. Indeed the advent of the electric car has resulted in significant research into high dielectric materials. The mass density differential should preferably be greater than approximately 10%, more preferably greater than 100% and most preferably more than 1000%. The precise density of the materials is not a critical factor, but denser materials will require fewer cells to achieve the desired thrust for the engine. The materials used for the electrodes should be as light as technology permits if the device is to be used to lift payloads against the pull of gravity.

Other aspects of the cylindrical and other capacitor configurations and preferred parameters, such as applied voltages etc., can be found in parent application Ser. No. 10/271,782, filed Oct. 17, 2002. In particular, FIGS. 1a, 1b, 7, 8a, 8b, and 8c are the most relevant cases as well as all the array configurations described in the parent patent application in which the cells depicted in the above Figures appear. In these configurations there is no need for a second low mass density dielectric. All that is required regarding the dielectric to achieve maximum force, is maximization of the mass density and the dielectric constant of the dielectric material between the electrodes as described in the parent patent application.

Basis For FC Thrust

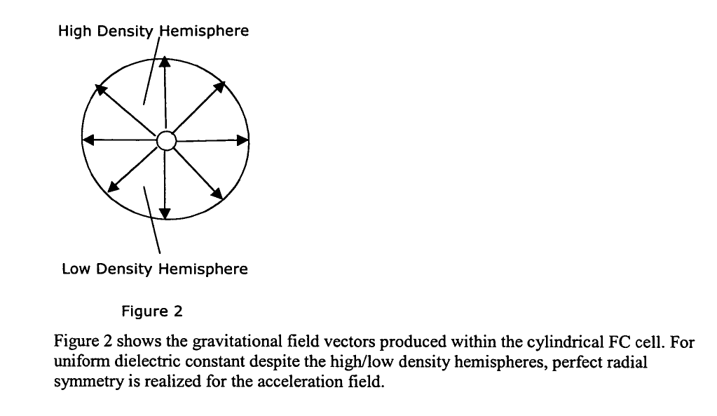

FIG. 2 shows the directions of the gravitational field vectors produced by a single cylindrical cell of the array of cells that will comprise an engine. This symmetry arises because the dielectric constant is uniform (constant) throughout the capacitor. The first order gravitational field for the cylindrical cell shown exhibits cross-sectional cylindrical symmetry that was theoretically calculated to be approximately 1 micro g for an electric field of 200V/mm at the surface of the inner conductor (Vargas and Torr, 2004b). It is expected on theoretical grounds that the field will scale linearly with both the dielectric constant and with the applied electric field.

Examination of the characteristics of the field shown in FIG. 2 shows that the field, created along the radial lines emanating from the center electrode and terminating on the outer electrode, will exert a force on all the dielectric material lying in its path. The net force acting on the center of mass of the system will be given by
F=Mg′, (6)
where M is the difference M₁-M₀, where M₁ and M₀, respectively, are the total masses of the high and low density dielectric materials, and g′ is the weighted average of the gravitational field acting on the center of mass of each of the high and low masses for constant k. If this force is aligned to oppose gravity, then all the mass surrounding the high and low density halves, respectively, must be taken into account as is done below.

It is to be noted that the components of gravitational fields normal to the plane dividing the high/low masses, i.e., the base plane of that hemisphere, will superpose to yield a non-zero, non-canceling acceleration field and net force, F, in a direction perpendicular to the plane dividing the high/low masses if M₀<M₁. The components of the field in directions parallel to the plane dividing the high/low mass will all cancel, yielding a net resultant of zero.

The basis for thrust is the theoretical expectation (coupled with the absence of logical alternatives) that the energy sustaining the interaction comes from the surrounding environment and the vacuum. The PST formulation links the source of gravitation to both the environment and the background that forms the substance of the vacuum—both through the dλ term in equation (4). In either case, the reactive effect of Newton's Third Law because of the dβ term is expected to be with respect to the energy source and not the cell itself, unlike the case for the electrostic forces present that also act on the dielectric.

Optimization of Cell Parameters for the Cylindrical Case

The force per unit mass produced by the electrically induced gravitational (EIG) field generated by the electric field E between cylindrical electrodes is inferred from Eq. (63) in (Vargas and Torr, 2004b). As a function of distance r from the central axis, it is given by
F_{EIG}/m=(G/2)^{1/2}E=(G/2)^{1/2}E₀r₀/r.=g′(r) (7)
where G is the Universal Gravitation Constant, and E₀ is the value of E at r₀, the outer radius of the inner electrode. Eq. (7) can therefore be written as
g′=g₀r₀/r (8)
where
g₀=(G/2)^{1/2} E₀ (9)
and where g′ is aligned in the radial direction. It is important to realize that since the source of this force is a (previously unknown) term in the expression for electromagnetic energy this force will be proportional to the dielectric constant k.

The two halves (i.e., two semi-cylinders) have the same electric properties (meaning the same constant k) but different mass densities. Because the electric properties are the same, the field of the system of two semi-cylinders is the same as if we had one cylinder made from just one material of the given k. Now we replace the dielectric in one of the halves with a different dielectric of the same dielectric constant k but different mass density. Let j be one of the two unit vectors normal to the base plane of the semi-cylinder. We shall refer to this direction as the vertical. As we already said, horizontal components of the EIG force on the mass of the dielectric of one of the halves will cancel out by symmetry. Only the vertical components survive. From Eqs. (7) and (8) the magnitude of the force generated by g′ acting on the mass of the dielectric in the volume, V, of one semi-cylinder is
F═∫F_{EIG}/m) cos θρdV j, (10)
where ρ is the mass density for the half cylinder, where θ is the angle measured from the vertical direction. The integration has to be performed between the outer radius ro of the inner electrode and the inner radius R of the outer electrode. These are, of course, the radii of the two materials that constitute the dielectric in each of the respective half cables.
We have dV=Ldr rdθ, and, therefore,

$$F = L ρλ {g}_{0} {r}_{0} {\int }_{{r}^{0}}^{R} ⅆ r {\int }_{- π / 2}^{0} cos θ ⅆ θ j , \qquad ( 11 )$$

Hence, we have:
F=Lρg₀r₀R−r₀)ⱼ (12)
We now multiply and divide by π(R+r₀) and use that the mass of the dielectric in a coaxial semi-cable is (ρπ/2)(R²−r₀²)L. In this way, we get:
F=(2/π)Mg₀(1+R/r₀)⁻¹j=Mg_{—}″j, (13)
where g″ is implicitly defined in (13).

To optimize the net force produced per cell, the applied electric field should be increased to close to the electric breakdown strength of the dielectric material, and the dielectric constant should be increased to that obtainable by the current state of the art. At this time ceramic dielectrics and various titinates are materials that can be fabricated with dielectric constants of the order of several thousand to several tens of thousands. Such dielectrics are produced the Ferro Corporation and molded by TCI. For example, increasing the dielectric constant from 1 (the value used in the theoretical calculation) to 10,000 will increase the strength of the EIG field from 1×10⁶ g's to 10 milli g's. Increasing the strength of the electric field from 200 volts/mm to 200,000 volts per millimeter will increase the strength of the EIG field from 10 milli g's to 10 g's. Although this is a large gravitational field, it should be noted that the first order gravitational fields do not escape the electrically shielded region, because the first order electric and gravitational potentials are identical in form for the electric and EIG fields. Thus, the gravitational field in first order is subject to the same laws that govern the behavior of the electric field, at least for spherical and cylindrical configurations. Higher order fields are non-linearly related to the electric field and are not governed by those laws, and will escape the source region; however, experimental results have shown that these fields are several orders of magnitude smaller than the calculated first order fields, which is consistent with theoretical order of magnitude estimates of the second order field.

A single cable with the following properties will produce a force of ˜1 gm per cable: E=200,000V/mm, dielectric constant k=20,000, inner electrode radius=50 microns, dielectric thickness 20 microns, cable length 6.5 cm, applied voltage 4000 volts, g′=10 g, cable weight ˜0.14 gm with a mass differential of a factor of 4. Any number of cables may be grouped together to produce a desired net force. Since the weight of the cable is less than the net force produced, there is essentially no limit to the number of cables that can be used for lifting purposes. Each cable must be oriented so that the direction of the force it exerts is pointed in the desired direction of the resultant force. The parameters selected above represent values close to the limit of current technology but probably well below the limits of future technology.

There are numerous applications for this technology. Lifting or weight reduction can be accomplished simply by placing enough cables in the most suitable configuration for the application for which examples of parameters are given below. The weight reduction could cover any range, preferably 1 ton, or more preferably 50 tons, or most preferably more than 500 tons. This is accomplished by adding more cables to the lifting system. The number of cables would depend on the specific parameters per cable. However, in general, a system would most preferably comprise of 0.1 million cables, more preferably of 50 million cables, and, for lifting very large loads, most preferably more than 1 billion cables.

At this time we are unable to compute the effect of asymmetries in the internal electrical properties between the electrodes, and thus cannot quantify the effect of combining a high mass density, high dielectric constant pair with a low mass density, low dielectric constant combination. It is possible that this could significantly decrease the net gravitational field produced in the low density half, and thereby increase further the net force produced.

Applications

Configuration for General Propulsion System: Lifting and Thrust

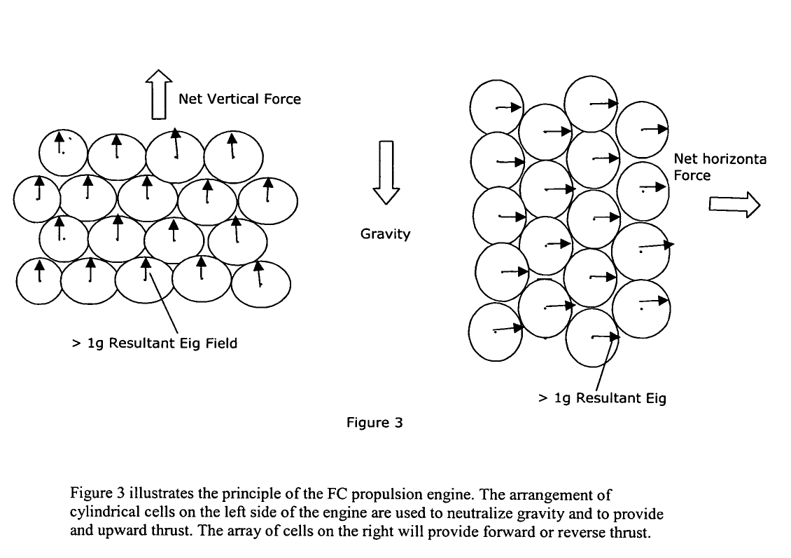

FIG. 3 illustrates schematically the principle of the FC lifting and propulsion engine. The arrangement of cylindrical cells on the left side of the engine are used to neutralize gravity and to provide an upward thrust. The array of cells on the right will provide forward or reverse thrust. A voltage is applied across the inner and outer electrodes of all cells. Connections are made at the end of an array of cells. One approach is to solder or epoxy the electrodes into a molded board that interconnects all the inner wires on the one hand and the outer on the other. (Note safety and reliability issues will require redundancy that may require a number of independently connected areas—each with its own power supply.) At micro-scales, micro-fabrication techniques are used. The outer shield would generally be grounded for safety reasons and the high voltage applied to the central wire. The direction of the gravitational field is reversed by reversing the polarity on the inner electrode.

The two components of the engine shown form the basis of the scheme that can be used to produce a net force in any desired direction. There is no constraint on how the cables are configured. For example, if placed in a flat bed format with all the resultant vectors per cable pointed upward, a net upward force will result that can be used for weight reduction or lifting for the appropriate selection of control parameters. An example of cable parameters (taken together with the electrical parameters above) that would be consistent with the volume of cables referred to above follows:
Inner conductor radius: 5 microns
Dielectric thickness: 10 microns
Thickness of outer shield: 5 microns.
Electric Field Strength: 200,000 volts/mm
Separation distance between cables: 5 to 10 microns
Dielectric constant: 10,000
Length of cable: 0.01 to 0.1 m (longer lengths can be made of segments)
Differential mass density factor: 4
   Configuration of a Rotary Motor or Electrical Power Generator

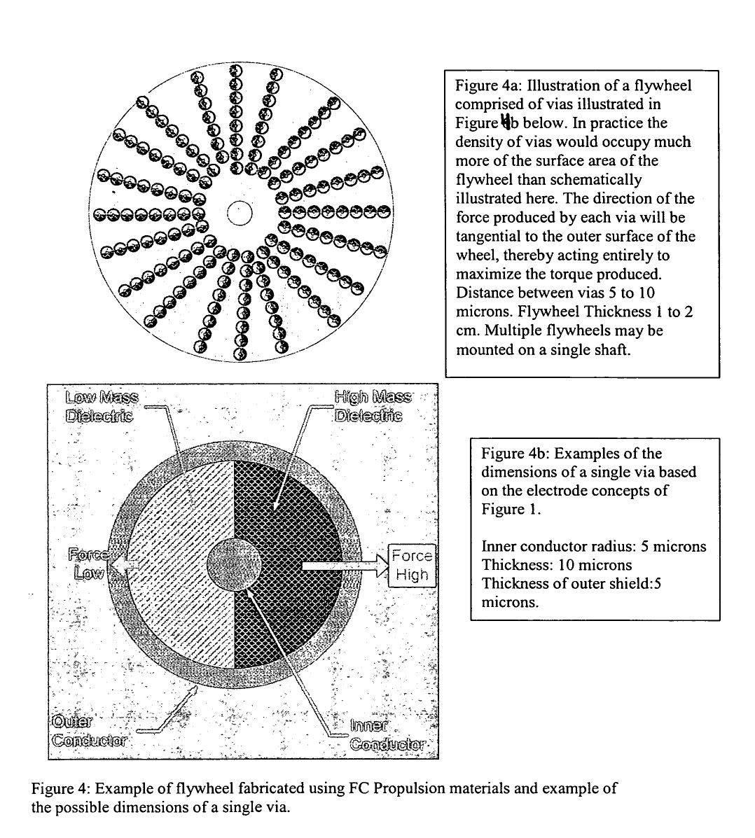

FIG. 4 shows the basis for a rotary motor in which the cables have been integrated and laser synthesized within a ceramic or composite wheel as described below. This fabrication technique could also be used in the examples cited above. In this case, the FC propulsion force vectors are aligned tangentially to the radius of the wheel while the FC cylinder is constructed perpendicular to the circular surface of the wheel to provide the torque that will drive the motor. The torque capability of the motor can be adjusted for a particular application by adjusting the thickness of the wheel (adjusts the length of the FC cylinder), the thickness of the dielectrics, the voltage applied, the dielectric constant of the dielectric, the number of cylinders constructed within the wheel, and the diameter of the wheel. The speed of the wheel can be controlled by adjusting the applied voltage to the FCs.

The FC cells can be constructed within the ceramic or composite wheel using laser and microelectronic construction methods. A simplified description for one possible construction process of the FCs is as follows. A laser is used to “drill” holes (vias) in the ceramic or composite material. A conductor is formed on the inside surface of the via using plating or laser synthesis methods. Dielectrics are grown within the via using masking or laser processes so that two different dielectrics are formed on each half of the cylinder. During the growth phase, the dielectrics are doped with appropriate metallic gasses to establish a differential mass of the dielectric materials. The dielectrics are “drilled” with a laser to form the region of the inner conductor. An inner conductor can be formed by using microelectronic or laser processes. The FC cylinders are connected together using microelectronic metallization techniques to connect the inner FC conductors and the outer FC conductors in parallel. Once again, the connections of the FCs may be grouped and driven from separate power supplies in order to improve system reliability, so that a short circuit failure in one of the FCs does not cause all the FCs to become non-functional.

The FCs will be driven by one or more high-voltage, current limited power supplies. These voltage supplies may be located on the center portion of the wheel, or alternatively off the wheel with electrical connections provided by brushes or rings. If the voltage supplies are located on the wheel, a source voltage can be applied to all the supplies with brushes or rings, or preferably by magnetic coupling to transformers within the supply using magnets that are located in fixed locations adjacent to the wheel. Once the motor has reached the specific speed, the power supplies only need to maintain leakage current for the vias. Since the FCs use high quality dielectrics, the capacitance will maintain the voltage across the cylinder with only nano amps or micro amps required to maintain the charge on the FC.

By using the motor to drive an electrical generator, the motor becomes a source of power to create electrical energy. Since, according to the PST theory, the energy source of the gravitational field is (simply expressed) the background energy, this motor can provide a source of clean power from a renewable energy source that has essentially zero recurring cost. Applications include large scale power generators, home power generators, power for electrically driven cars, as well as direct propulsion and braking for cars using the concepts illustrated in FIG. 3.

The method can also be used to provide a very long life small power source as a replacement, enhancement, or alternative to batteries for many spheres of application such as portable consumer electronics, including laptop computers, cell phones, personal digital assistants, and implanted biomedical equipment. This motor can operate independently in remote applications, such as space missions and third world energy production, or can be operated within the electrical energy grid to provide distributed power at the point of use. The integration of the FC motor to provide distributed power within the electrical grid can use technology developed for other renewable sources such as wind mills, but will be modified to take advantage of the much higher rotational speeds possible from the FC motor. When used as a generator in an electric vehicle, the generator can be the charging source for a battery or kinetic flywheel to provide the charging power to provide unlimited range for an electric vehicle. Alternatively, a smaller motor generator can be optimized to provide the required range based on the percent utilization of the vehicle. The capability to produce low cost power can change the world for the better by eliminating our dependence on oil and the associated environmental consequences, providing electrical power for desalinization, providing electrical energy for developing nations, and enabling more efficient transportation systems,

A one (1) meter diameter flywheel with an active thickness of only 4 centimeters manufactured with approximately 5 million vias of FIG. 4 and the parameters above is projected to produce about 400 kilo watts of power continuously. Alternatively, a 12″ diameter flywheel with an active thickness of only 1 centimeter manufactured with approximately 100K vias of FIG. 4 and parameters above is projected to produce 2 kilo watts of power continuously, or enough to power the average household. Portable power generators can be constructed with wheels of less than 2 inches in diameter to provide power levels of up to 50 watts of continuous power.

1. An apparatus for generating an inhomogeneous electric field that can produce thrust comprising:
a first electrode constructed of a first conducting material;
a second electrode constructed of a second conducting material separated from but in proximity of the first electrode; and
a first and second dielectric material interposed between the first and second electrodes, the first and second dielectric materials having a high and low mass density, respectively.

2. The apparatus of claim 1 wherein the first and second dielectric materials have substantially the same dielectric constant.

3. The apparatus of claim 1 wherein the first and second dielectric materials have a dielectric constant of 5000 or greater.

4. The apparatus of claim 1 wherein the first and second dielectric materials have a dielectric constant of 10,000 or greater.

5. The apparatus of claim 1 wherein the first and second dielectric materials have a dielectric constant of 50,000 or greater.

6. The apparatus of claim 1 wherein the first and second conducting materials are a metal or a conductive ceramic.

7. The apparatus of claim 6 wherein the metal is aluminum, copper, silver or gold.

8. The apparatus of claim 1 wherein the apparatus is a cylindrical capacitor.

9. The apparatus of claim 1 wherein the mass density differential between the first and second dielectric materials is greater than about 10%.

10. The apparatus of claim 1 wherein the mass density differential between the first and second dielectric materials is greater than about 100%.

11. The apparatus of claim 1 wherein the mass density differential between the first and second dielectric materials is greater than about 1000%.

12. The apparatus of claim 1 wherein the high density material fills about one-half of the space between the first and second electrodes, and the low density material fills about the other half.

13. The apparatus of claim 12 wherein the inhomogeneous electric field in a perpendicular plane normal to a base plane dividing the high and low density materials is a non-zero, non-canceling field.

14. The apparatus of claim 1 wherein the electrodes are charged with a potential difference generating the inhomogeneous electric field.

15. The apparatus of claim 14 wherein the inhomogeneous electric field is close to but below the electric breakdown strength of the dielectric materials.

16. An array of cells for generating an inhomogeneous electric field that can produce thrust wherein each cell comprises:
a first electrode constructed of a first conducting material;
a second electrode constructed of a second conducting material separated from but in proximity of the first electrode; and
first and second dielectric materials interposed between the first and second electrodes, the first and second dielectric materials having a high and low mass density, respectively.

17. The array of cells of claim 16 wherein the array comprises more than 1,000,000 cells.

18. The array of cells of claim 16 wherein the array comprises more than 5,000,000 cells.

19. The array of cells of claim 16 wherein the array comprises more than 10,000,000,000 cells.

20. An array comprising:
a first plurality of cells, each cell of the first plurality of cells generating an inhomogeneous electric field having a first field vector along which the inhomogeneous electric field has a maximum magnitude, wherein the first plurality of cells are oriented such that the respective first field vectors of maximum magnitude are commonly aligned in an opposite direction to the force of gravity; and
a second plurality of cells, each cell of the second plurality of cells generating an inhomogeneous electric field having a second field vector along which the inhomogeneous electric field has a maximum magnitude, wherein the second plurality of cells are oriented such that the respective second field vectors of maximum magnitude are commonly aligned in a direction substantially normal to the force of gravity;
each cell of the first and second plurality of cells comprising:
a first electrode constructed of a first conducting material;
a second electrode constructed of a second conducting material separated from but in proximity of the first electrode; and
a first and second dielectric material interposed between the first and second electrodes, the first and second dielectric materials having a high and low mass density, respectively.

21. The array of claim 20 wherein the first and second dielectric materials have substantially the same dielectric constant.

22. The apparatus of claim 20 wherein the first and second dielectric materials have a dielectric constant of 5000 or greater.

23. The apparatus of claim 20 wherein the first and second dielectric materials have a dielectric constant of 10,000 or greater.

24. The apparatus of claim 20 wherein the first and second dielectric materials have a dielectric constant of 50,000 or greater.

25. The apparatus of claim 20 wherein the mass density differential between the first and second dielectric materials is greater than about 10%.

26. The apparatus of claim 20 wherein the mass density differential between the first and second dielectric materials is greater than about 100%.

27. The apparatus of claim 20 wherein the mass density differential between the first and second dielectric materials is greater than about 1000%.

28. A combination of a flywheel and a plurality of cells mounted on the flywheel comprising:
each cell of the plurality of cells generating an inhomogeneous electric field having a field vector along which the inhomogeneous electric field has a maximum magnitude, wherein the plurality of cells are oriented such that the respective field vectors of maximum magnitude are tangential to an outer surface of the flywheel;
each cell of the plurality of cells comprising:
a first electrode constructed of a first conducting material;
a second electrode constructed of a second conducting material separated from but in proximity of the first electrode; and
a first and second dielectric material interposed between the first and second electrodes, the first and second dielectric materials having a high and low mass density, respectively.

29. The combination of claim 28 wherein the plurality of cells are mounted along radial lines of the flywheel.

30. The combination of claim 28 wherein the plurality of cells are mounted in vias of the flywheel.

31. The combination of claim 30 wherein the vias are about 5 to 10 microns apart.

32. The combination of claim 31 wherein the flywheel has a thickness of about 1 to 2 cm.
